(19) United States
(12) Patent Application Publication
(10) Pub. No.: US 2011/0054120 A1
(43) Pub. Date: Mar. 3, 2011

(54) WATER DISPERSION OF AROMATIC POLYSULFONE RESIN PARTICLES

(75) Inventors: Yusaku KOHINATA, Tokyo (JP); Hiroshi HARADA, Tsukuba-shi (JP)

(73) Assignee: SUMITOMO CHEMICAL COMPANY, LIMITED, Tokyo (JP)

(21) Appl. No.: 12/871,207

(22) Filed: Aug. 30, 2010

(30) Foreign Application Priority Data
Aug. 31, 2009 (JP) 2009-199762

(51) Int. Cl. C09D 181/06

(52) U.S. Cl. 524/609

(57) ABSTRACT

The present invention provides a dispersion in which aromatic polysulfone resin particles are dispersed in water. The aromatic polysulfone resin particles comprises a aromatic polysulfone resin having oxygen-containing groups selected from among hydroxyl groups and oxyanion groups in an amount of 1.6 or more groups relative to 100 repeating units forming the aromatic polysulfone resin; and have the volume average particle diameter of 50 μm or less. The dispersion is less likely to cause settlement of the aromatic polysulfone particles and is suited for use as an aqueous coating material.

### BACKGROUND OF THE INVENTION

1. Field of the Invention

The present invention relates to a dispersion in which aromatic polysulfone resin particles are dispersed in water.

2. Description of the Related Art

Since an aromatic polysulfone resin is excellent in heat resistance and chemical resistance, the resin is used in various applications. As one of the usages, the aromatic polysulfone resin is used in a coating material in a form of a solution or a dispersion. For example, JP-A-2001-146571 discloses a coating material containing an aromatic polysulfone resin, a fluororesin and an organic solvent, and is proposed that an aromatic polysulfone resin having a terminal hydroxyl group and having a predetermined reduced viscosity be used as the aromatic polysulfone resin.

### SUMMARY OF THE INVENTION

As the coating material, more preferred is an aqueous coating material in which water is contained as a dispersing medium than an oily coating material in which an organic solvent is contained as a dispersing medium from a viewpoint of improvement in work environment on preparation or coating processing, and also from a viewpoint of saving costs of disposal and recovery of an organic solvent. However, it is difficult for an aromatic polysulfone resin to be dissolved in water and, when the aromatic polysulfone resin particles used for conventional coating materials are dispersed in water, the particles are easily settled while dispersibility is inferior. Accordingly, one of objectives of the present invention is to provide a dispersion of aromatic polysulfone particles containing water as a dispersing medium, which is less likely to cause settlement of the aromatic polysulfone particles and is suited for use as an aqueous coating material.

In order to attain the above objective, the present invention provides a dispersion in which an aromatic polysulfone resin particles satisfying the following requirements (a) and (b) are dispersed in water:

(a) the aromatic polysulfone resin forming the aromatic polysulfone resin particles has oxygen-containing groups selected from among hydroxyl groups and oxyanion groups in an amount of 1.6 or more groups relative to 100 repeating units forming the aromatic polysulfone resin; and

(b) the volume average particle diameter of the aromatic polysulfone resin particles is 50 μm or less.

The present invention also provides a coating material comprising the dispersion.

In the dispersion of the present invention, since the aromatic polysulfone resin particles are dispersed in water in a state where the particles are less likely to be settled, the dispersion can be suitably used as an aqueous coating material, which is capable of providing a coating film excellent in heat resistance and chemical resistance.

### DETAILED DESCRIPTION OF THE INVENTION

A dispersion of the present invention comprises an aromatic polysulfone resin particles and water, in which the aromatic polysulfone resin particles are dispersed in water.

The aromatic polysulfone resin forming the aromatic polysulfone resin particles is a resin having a repeating unit containing an aromatic group (namely, a residue obtained by removing, from an aromatic compound, two hydrogen atoms bound to its aromatic ring) and a sulfonyl group (—SO₂—). It is preferable that the aromatic polysulfone resin has a repeating unit represented by the following formula (1) (hereinafter sometimes referred to as “repeating unit (1)”) from the viewpoint of heat resistance and chemical resistance, and may further have other repeating units such as a repeating unit represented by the following formula (2) (hereinafter, sometimes referred to as “repeating unit (2)”) and a repeating unit represented by the following formula (3) (hereinafter, sometimes referred to as “repeating unit (3)”). The aromatic polysulfone resin has the repeating unit (1) in the proportion of 50 to 100 mol %, and more preferably 80 to 100 mol %, based on the total of all repeating units.

—Ph¹—SO₂—Ph²—O— (1)

In the formula (1) Ph¹ and Ph² each independently represent a phenylene group, and the hydrogen atoms present in the phenylene group each independently may be substituted with an alkyl group, an aryl group or a halogen atom.

—Ph³—R—Ph⁴—O— (2)

In the formula (2) Ph³ and Ph⁴ each independently represent a phenylene group, hydrogen atoms present in the phenylene group may be each independently substituted with an alkyl group, an aryl group or a halogen atom, and R represents an alkylidene group, an oxygen atom or a sulfur atom.

—(Ph⁵)ₙ—O— (3)

In the formula (3) Ph⁵ represents a phenylene group, hydrogen atoms present in the phenylene group may be each independently substituted with an alkyl group, an aryl group or a halogen atom, and n represents an integer of 1 to 3 and, when n is 2 or more, a plurality of Ph⁵(s) may be the same or different.

The phenylene group represented by any one of Ph¹ to Ph⁵ may be a p-phenylene group, a m-phenylene group or an o-phenylene group, and is preferably a p-phenylene group. Examples of the alkyl group which may replace a hydrogen atom present in the phenylene group include a methyl group, an ethyl group, a n-propyl group, an isopropyl group, a n-butyl group, an isobutyl group, an s-butyl group and a t-butyl group, and the number of carbon atoms may be in the range of from 1 to 5. Examples of the aryl group which may replace a hydrogen atom present in the phenylene group include a phenyl group, a 1-naphthyl group, a 2-naphthyl group and a p-tolyl group, and the number of carbon atoms may be in the range of from 6 to 15. Examples of the alkylidene group represented by R include a methylene group, an ethylidene group, an isopropylidene group and a 1-butylidene group, and the number of carbon atoms may be in the range of from 1 to 5.

In the present invention, the aromatic polysulfone resin forming the aromatic polysulfone resin particles has oxygen-containing groups selected from among hydroxyl groups and oxyanion groups in an amount of 1.6 or more groups relative to 100 repeating units forming the aromatic polysulfone resin. Please note that the oxyanion group is a group generated by dissociating a proton from the hydroxyl group.

By using the aromatic polysulfone resin having such oxygen-containing groups in the amount in the range as described above, dispersibility of particles of the aromatic polysulfone resin in water can be improved. Moreover, the amount of such oxygen-containing groups may be 4 or less, and is preferably 3 or less, relative to 100 repeating units of the aromatic polysulfone resin.

It is preferable that the above-described oxygen-containing groups are all hydroxyl groups. The oxygen-containing groups are preferably bonded to aromatic ring(s) of the aromatic polysulfone resin so as to serve as phenolic hydroxyl or oxyanion groups. Also, the oxygen-containing group(s) are preferably placed at terminal(s) of a main chain of the resin.

The oxyanion group typically exists with a counter-cation attached thereto. Examples of the counter-cation include alkali metal ions such as a lithium ion, a sodium ion and a potassium ion, alkaline earth metal ions such as a magnesium ion and a calcium ion, ammonium ions obtained by protonating ammonia or primary to tertiary amine, and quaternary ammonium ions. When the counter-cation is a polyvalent cation such as an alkaline earth metal ion, the counter-anion may be comprised of a plurality of oxyanion groups, or may be comprised of an oxyanion group, and other anions such as a chloride ion and a hydroxide ion.

The aromatic polysulfone resin used in the present invention has a reduced viscosity of preferably from 0.25 to 0.60 dL/g, more preferably from 0.30 to 0.55 dL/g, and still more preferably from 0.36 to 0.55 dL/g. If the reduced viscosity of the aromatic polysulfone resin is too small, when the resulting dispersion is used as a coating material, the strength of a coating film is likely to be reduced and, if the reduced viscosity of the aromatic polysulfone resin is too large, the resulting aromatic polysulfone resin particles becomes hard to be ground.

In addition, the aromatic polysulfone resin used in the present invention has a 5% weight loss temperature in thermogravimetry of preferably 400° C. or higher, from the viewpoint of durability of a coating film when the resulting dispersion is used as a coating material. Here, the 5% weight loss temperature in thermogravimetry is a temperature at which a weight of the resin is reduced by 5% compared to the weight of the resin at 25° C. under the conditions of heating in a thermogravimetry analysis (TGA), and can be measured using an analysis device, model TGA7 manufactured by Perkin-Elmer Co., Ltd. while heating at a ratio of 20° C./min. in a nitrogen gas flow.

The aromatic polysulfone resin can be suitably produced by polycondensing a corresponding aromatic dihalogenosulfone compound and an aromatic dihydroxy compound in an organic highly polar solvent using an alkali metal salt of carbonic acid. For example, a resin having the repeating unit (1) can be produced using a compound represented by the following formula (4) (hereinafter sometimes referred to as “compound (4)”) as the aromatic dihalogenosulfone compound, and using a compound represented by the following formula (5) (hereinafter sometimes referred to as “compound (5)”) as the aromatic dihydroxy compound. In addition, a resin having the repeating unit (1) and the repeating unit (2) can be produced by using the compound (4) as the aromatic dihalogenosulfone compound, and using a compound represented by the following formula (6) (hereinafter sometimes referred to as “compound (6)”) as the aromatic dihydroxy compound. In addition, a resin having the repeating unit (1) and the repeating unit (3) can be produced by using the compound (4) as the aromatic dihalogenosulfone compound, and a compound represented by the following formula (7) (hereinafter sometimes referred to as “compound (7)”) as the aromatic dihydroxy compound.

X¹—Ph¹—SO₂—Ph²—X² (4)

In the formula (4) X¹ and X² each independently represent a halogen atom, and Ph¹ and Ph² are as defined above.

HO—Ph¹—SO₂—Ph²—OH (5)

In the formula (5) Ph¹ and Ph² are as defined above.

HO—Ph³—R—Ph⁴—OH (6)

In the formula (6) Ph³, Ph⁴ and R are as defined above.

HO—(Ph⁵)ₙ—OH (7)

In the formula (7) Ph⁵ and n are as defined above.

Examples of the compound (4) include bis(4-chlorophenyl)sulfone and 4-chlorophenyl-3′, 4′-dichlorophenylsulfone. Examples of the compound (5) include bis(4-hydroxyphenyl)sulfone, bis(4-hydroxy-3,5-dimethylphenyl)sulfone and bis(4-hydroxy-3-phenylphenyl)sulfone. Examples of the compound (6) include 2,2-bis(4-hydroxyphenyl)propane, 2,2-bis(4-hydroxyphenyl)hexafluoropropane, bis(4-hydroxyphenyl) sulfide, bis(4-hydroxy-3-methylphenyl) sulfide and bis(4-hydroxyphenyl) ether. Examples of the compound (7) include hydroquinone, resorcin, catechol, phenylhydroquinone, 4,4′-dihydroxybiphenyl, 2,2′-dihydroxybiphenyl, 3,5,3′,5′-tetramethyl-4,4′-dihydroxybiphenyl, 2,2′-diphenyl-4,4′-dihydroxybiphenyl and 4,4′′′-dihydroxy-p-quarterphenyl.

Examples of the aromatic dihalogenosulfone compound other than the compound (4) include 4,4′-bis(4-chlorophenylsulfonyl)diphenyl. Further, in place of all or a part of the aromatic dihalogenosulfone compound and/or the aromatic dihydroxy compound, a compound having a halogeno group and a hydroxyl group in a molecule such as 4-hydroxy-4′-(4-chlorophenylsulfonyl)biphenyl can also be used.

The alkali metal salt of carbonic acid may be alkali carbonate which is a normal salt, alkali bicarbonate (hydrogen alkali carbonate) which is an acidic salt, or a mixture of both of them. As the alkali carbonate, sodium carbonate and potassium carbonate are preferably used and, as the alkali bicarbonate, sodium bicarbonate and potassium bicarbonate are preferably used.

Examples of the organic highly polar solvent include dimethyl sulfoxide, 1-methyl-2-pyrrolidone, sulfolane(1,1-dioxothiolan), 1,3-dimethyl-2-imidazolidinone, 1,3-diethyl-2-imidazolidinone, dimethylsulfone, diethylsulfone, diisopropylsulfone and diphenylsulfone.

The above-described reaction for the aromatic polysulfone resin is dehydrohalogenation polycondensation between the aromatic dihalogenosulfone compound and the aromatic dihydroxy compound and, if no side reaction occurs, as a molar ratio of both of them is nearer 1:1, that is, as the amount of the aromatic dihalogenosulfone compound used is nearer 100 mol % based on the aromatic dihydroxy compound, there is a tendency that a polymerization degree of the resulting aromatic polysulfone resin becomes higher, and a reduced viscosity becomes higher. However, actually, a side reaction such as a substitution reaction and depolymerization from halogeno groups to the oxygen-containing groups occurs due to alkali hydroxide or the like as a byproduct, and there is a tendency that a polymerization degree of the resulting aromatic polysulfone resin is reduced due to this side reaction, and a reduced viscosity is reduced, and there is also a tendency that the number of the oxygen-containing groups is increased. In addition, if no side reaction occurs, since as the amount of an alkali metal salt of carbonic acid is larger, objective polycondensation proceeds more rapidly, there is a tendency that a polymerization degree of the resulting aromatic polysulfone resin becomes higher, and a reduced viscosity becomes higher. However, actually, as the amount of an alkali metal salt of carbonic acid used is larger, the side reaction described above easily occurs. Further, if no side reaction occurs, since as a polycondensation temperature is higher, objective polycondensation proceeds more rapidly, there is a tendency that a polymerization degree of the resulting aromatic polysulfone resin becomes higher, and a reduced viscosity becomes higher. However, actually, as a polycondensation temperature used is higher, the side reaction described above easily occurs. Therefore, in view of a degree of this side reaction, it is preferable that the amount of the aromatic dihalogenosulfone compound used, the amount of the alkali metal salt of carbonic acid used, and the polycondensation temperature are adjusted so that the aromatic polysulfone resin having the oxygen-containing groups at the predetermined number or more is obtained, preferably so that the aromatic polysulfone resin having a suitable reduced viscosity is obtained.

The amount of the aromatic dihalogenosulfone compound used may be in the range of from 80 to 105 mol %, and preferably from 98 to 100 mol %, based on the aromatic dihydroxy compound.

The amount of the alkali metal salt of carbonic acid used may be 95 mol % or more as an alkali metal based on the hydroxyl group of the aromatic dihydroxy compound. In addition, if the amount of the aromatic dihalogenosulfone compound used may be in the range of from 80 to 98 mol % based on the aromatic dihydroxy compound, the amount of the alkali metal salt of carbonic acid used may be in the range of from 95 to 100.5 mol% as an alkali metal based on the hydroxyl group of the aromatic dihydroxy compound and, if the amount of the aromatic dihalogenosulfone compound used is from 98 to 105 mol % based on the aromatic dihydroxy compound, the amount of the alkali metal salt of carbonic acid may be in the range of from 100.5 to 140 mol % as an alkali metal based on the hydroxyl group of the aromatic dihydroxy compound.

In a typical process for producing an aromatic polysulfone resin, an aromatic polysulfone resin is obtained by dissolving an aromatic dihalogenosulfone compound and an aromatic dihydroxy compound in an organic polar solvent as a first stage, adding an alkali metal salt of carbonic acid to the resulting solution, and polycondensing the aromatic dihalogenosulfone compound and the aromatic dihydroxy compound as a second stage, and removing an unreacted alkali metal salt of carbonic acid, an alkali metal salt such as alkali halide as a byproduct, and the organic polar solvent from the resulting reaction mixture as a third stage.

A dissolution temperature at the first stage may be in the range of from 40 to 180° C., and a polycondensation temperature at second stage may be in the range of from 180 to 400° C. As the polycondensation temperature is higher, there is a tendency that an aromatic polysulfone resin having a high molecular weight and a high reduced viscosity is obtained, and this is preferable, but when the polycondensation temperature is too high, a side reaction such as degradation easily occurs, and this is not preferable. On the other hand, when the polycondensation temperature is too low, the reaction is slow, and this is not preferable. It is favorable that the polycondensation reaction may be performed by gradually raising a temperature while removing water as a byproduct, and further stirring the materials for typically from 1 to 50 hours, and preferably from 10 to 30 hours, after the temperature has reached a refluxing temperature of an organic polar solvent.

In place of the aforementioned first stage and second stage, first, an alkali metal salt of carbonic acid, an aromatic dihydroxy compound and an organic polar solvent are mixed and allowed to react, water as a byproduct is taken out and, then, the reaction is mixed with an aromatic dihalogenosulfone compound, and thereby, polycondensation may be performed, and this method is mainly adopted when the amount of the aromatic dihalogenosulfonic acid used is from 80 to 98 mol % based on the aromatic dihydroxy compound. If this method is adopted when the amount of the aromatic dihalogenosulfone compound used is from 98 to 105 mol % based on the aromatic dihydroxy compound, since the number of hydroxyl groups is reduced, this is not preferable. In this method, in order to take out water from the reaction solution, an organic solvent which is azeotropic with water may be mixed into the reaction solution, resulting in azeotropic dehydration. Examples of the organic solvent which is azeotropic with water include benzene, chlorobenzene, toluene, methyl isobutyl ketone, hexane and cyclohexane. A temperature for performing azeotropic dehydration may be in the range of from 70 to 200° C., while depending on a temperature at which an azeotropic solvent is azeotropic with water.

At the third stage, an unreacted alkali metal salt of carbonic acid, and an alkali metal salt such as alkali halide as a byproduct are removed from the reaction mixture obtained at the second stage with a filtering equipment or a centrifuge, and thereby, a solution in which the organic polysulfone resin is dissolved in the organic polar solvent can be obtained. By removing the organic polar solvent from the solution, the aromatic polysulfone resin is obtained. Removal of the organic polar solvent may be performed by distilling the organic polar solvent off directly from the solution, or may be performed by once placing the solution in a poor solvent for the aromatic polysulfone resin to precipitate the aromatic polysulfone resin, and separating the resin by filtration or centrifugation.

In addition, if an organic polar solvent having a relatively high melting point is used as a polymerization solvent, it is also possible that the reaction mixture obtained at the second stage is cooled to solidify, the solid solution is ground and, thereafter, an alkali metal salt of carbonic acid, an alkali metal salt such as alkali halide as a byproduct, and an organic polar solvent are extracted and removed using water, and a solvent having no dissolving ability for an aromatic polysulfone resin, and having dissolving ability for an organic polar solvent.

A particle diameter after grinding is preferably from 200 to 2,000 μm as a central particle diameter, from the viewpoint of extraction efficacy and workability at extraction. When the particle diameter is too great, extraction efficacy is deteriorated and, when the particle diameter is too small, caking occurs upon solution extraction, and clogging is caused when filtration or drying is performed after extraction, being not preferable. The particle diameter after grinding is preferably from 250 to 1,500 μm, and more preferably from 300 to 1,000 μm.

As an extraction solvent, for example, if diphenylsulfone is used as a polymerization solvent, a mixed solvent of acetone and methanol can be used. Herein, a ratio of mixing acetone and methanol may be determined from extraction efficacy, and agglomeration property of aromatic polysulfone resin powder.

The aromatic polysulfone resin used in the present invention can be produced as described above, while a commercially available aromatic polysulfone resin (for example, “Sumika Excel 5003P” manufactured by Sumitomo Chemical Co., Ltd.) can be used as the aromatic polysulfone resin.

The dispersion of the present invention is a dispersion in which the particles comprising the aromatic polysulfone resin having the oxygen-containing groups selected from among hydroxyl groups and oxyanion groups at the predetermined number or more as described above is dispersed in water, the particles having a volume average particle diameter of 50 μm or less. By using the aromatic polysulfone resin particles having a volume average particle diameter of a predetermined value or less as described above, a dispersion in which the aromatic polysulfone particles are settled with difficulty and which is excellent in dispersibility can be obtained. A volume average particle diameter of the aromatic polysulfone resin particles is preferably 30 μm or less from the viewpoint of further improvement in dispersibility. In addition, since when the volume average particle diameter of the aromatic polysulfone resin particles is too small, an amount obtained at the time of mechanical grinding is easily decreased, the particle diameter may be 5 μm or more.

Since the aromatic polysulfone resin particles produced as described above and commercially available aromatic polysulfone resin particles may have a relatively great volume average particle diameter, it is preferable to grind them to have a volume average particle diameter of 50 μm or less by mechanical grinding for providing the dispersion of the present invention. A method of mechanical grinding is appropriately selected, and it is preferable to perform the method using an impact-type grinding machine. In addition, the environment of mechanical grinding may be under a normal temperature (of from 0° C. to 40° C.), or under a low temperature (lower than −100° C). using liquid nitrogen or the like, and is preferably under a low temperature, from the viewpoint of grinding efficacy.

Dispersing of the aromatic polysulfone resin particles into water may be performed by, if necessary, adding a surfactant and other components or performing ultrasound treatment, so that a concentration of the aromatic polysulfone resin particles in the dispersion becomes typically 50% by weight or less, and preferably 30% by weight or less. The thus obtained dispersion can be suitably used as an aqueous coating material giving a coating film excellent in heat resistance and chemical resistance, by utilizing heat resistance and chemical resistance of the aromatic polysulfone resin.

### EXAMPLES

Examples of the present invention will be shown below, but the present invention is not limited thereto.

### [Measurement of Number of the Oxygen-Containing Groups in Aromatic Polysulfone Resin]

A predetermined amount of an aromatic polysulfone resin was dissolved in dimethylformamide, and an excessive amount of paratoluenesulfonic acid was added. This solution was titrated with a 0.05 mol/L potassium methoxide/toluene methanol solution using a potentiometric titrator, remaining paratoluenesulfonic acid was neutralized, and a hydroxyl group was neutralized. Since an amount of potassium methoxide (mol was converted into number) requiring this neutralization of a hydroxyl group corresponds to the number of the oxygen-containing groups in the above-described predetermined amount of the aromatic polysulfone resin, and a value (mol was converted into number) obtained by dividing the predetermined amount (g) of the aromatic polysulfone resin by a formula weight (g/mol) of a repeating unit of the aromatic polysulfone resin corresponds to the number of repeating units in the predetermined amount of the aromatic polysulfone resin, the number of the oxygen-containing groups (selected from among hydroxyl groups and oxyanion groups) in an amount of 1.6 or more groups relative to 100 repeating units forming the aromatic polysulfone resin was obtained by dividing the former by the latter, and multiplying 100.

### [Measurement of Reduced Viscosity of Aromatic Polysulfone Resin]

About 1 g of an aromatic polysulfone resin was dissolved in N,N-dimethylformamide to make its volume 1dL, and a viscosity (η) of this solution was measured at 25° C. using an Ostwald-type viscosity tube. A viscosity (η₀)of N,N-dimethylformamide which is a solvent was measured at 25° C. using an Ostwald-type viscosity tube. A specific viscosity rate ((η−η₀)/η₀ was obtained from the viscosity (η) of the solution and the viscosity (η₀ ) of the solvent, and this specific viscosity rate was divided by a concentration of the solution (about 1 g/dL), and thereby, a reduced viscosity (dl/g) of the aromatic polysulfone resin was obtained.

### [Measurement of Volume Average Particle Diameter of Aromatic Polysulfone Resin Particles]

Water in which a dispersant (“nonionic surfactant Emulgen”, manufactured by Kao Corporation) was dissolved to a concentration of around a few tens ppm was used as a measurement solvent, and aromatic polysulfone particles were added thereto, the mixture was slightly loosened by ultrasound to make it dispersed, and the volume average particle diameter was measured using a laser diffraction scattering particle size distribution measuring machine (“LMS-30”, manufactured by SEISHIN ENTERPRISE CO., LTD.).

### [Assessment of Dispersibility of Aromatic Polysulfone Resin Particles]

A dispersion of aromatic polysulfone resin particles in water was placed into a cell for measurement and, regarding its intermediate part in the vertical direction, a color tone was measured in a transparent mode using a color tone measuring machine (“color difference meter ZE-2000”, manufactured by NIPPON DENSHOKU INDUSTRIES CO., LTD), and transparency (L value) after 1 minute, 5 minutes and 20 minutes from measurement initiation was determined. As this transparency is lower, this means that particles are dispersed better.

### Examples 1 to 5, and Comparative Examples 1 to 3

Aromatic polysulfone resin particles (“Sumika Excel 5003P”, manufactured by Sumitomo Chemical Co., Ltd., containing 2 oxygen-containing groups relative to 100 repeating units forming the aromatic polysulfone resin; and having a reduced viscosity of 0.515 dL/g and a volume average particle diameter of 352 μm) were ground at a low temperature with an impact-type mechanical grinding machine to obtain particles A having a volume average particle diameter of 8 μm, particles B having a volume average particle diameter of 20 μm, and particles C having a volume average particle diameter of 24 μm. The unground particles were used as particles D. In addition, aromatic polysulfone resin particles (“Sumika Excel 4100MP”, manufactured by Sumitomo Chemical Co., Ltd., containing no hydroxyl/oxyanion group; and having a reduced viscosity of 0.41 dL/g and a volume average particle diameter of 12 μm) were used as particles E.

Pure water (15 mL), particles A to E in each amount shown in Table 1, and 50 μL of a surfactant (polyoxyethylene alkyl ester) were added to a 50 mL conical beaker, followed by stirring for 30 minutes. Thereafter, ultrasound treatment was performed for 10 minutes to obtain a dispersion of the aromatic polysulfone resin particles in water. Regarding this dispersion, dispersibility was assessed, and results are shown in Table 1.

TABLE 1

| | | | Dispersibility: transparency (%) | | |
|---|---|---|---|---|---|
| | Particles | | After 1 | After 5 | After 20 |
| Examples | Kind | Amount (g) | minute | minutes | minutes |
| Example 1 | A | 0.015 | 14 | 15 | 19 |
| Example 2 | B | 0.015 | 43 | 62 | 76 |
| Example 3 | C | 0.015 | 47 | 69 | 78 |
| Comparative | E | 0.015 | 51 | 72 | 90 |
| Example 1 | | | | | |
| Comparative | D | 0.015 | 98 | 99 | 99 |
| Example 2 | | | | | |
| Example 4 | A | 0.045 | 5 | 5 | 6 |
| Example 5 | B | 0.045 | 9 | 20 | 51 |
| Comparative | E | 0.045 | 15 | 27 | 53 |
| Example 3 | | | | | |

1. A dispersion in which aromatic polysulfone resin particles satisfying the following requirements (a) and (b) are dispersed in water:
(a) the aromatic polysulfone resin forming the aromatic polysulfone resin particles has oxygen-containing groups selected from among hydroxyl groups and oxyanion groups in an amount of 1.6 or more groups relative to 100 repeating units forming the aromatic polysulfone resin; and
(b) the volume average particle diameter of the aromatic polysulfone resin particles is 50 μm or less.

2. The dispersion according to claim 1, wherein the aromatic polysulfone resin is a resin having a repeating unit represented by the following formula (1):
—Ph1—SO2—Ph2—O— (1)
wherein Ph1 and Ph2 each independently represent a phenylene group in which the hydrogen atoms present in the phenylene group each independently may be substituted with an alkyl group, an aryl group or a halogen atom.

3. The dispersion according to claim 1, wherein the aromatic polysulfone resin has a reduced viscosity of from 0.25 to 0.60 dL/g.

4. The dispersion according to claim 1, wherein the aromatic polysulfone resin has a 5% weight loss temperature in thermogravimetry of 400° C. or higher.

5. A coating composition comprising the dispersion according to claim 1.
